(19) United States
(12) Patent Application Publication
(10) Pub. No.: US 2016/0178966 A1
(43) Pub. Date: Jun. 23, 2016

(54) MANUFACTURE METHOD OF QUANTUM-DOT COLOR FILTER AND LIQUID CRYSTAL DISPLAY DEVICE

(71) Applicant: Shenzhen China Star Optoelectronics Technology Co., Ltd., Shenzhen, Guangdong (CN)

(72) Inventors: Ji Li, Shenzheni (CN); Xiaolong Ma, Shenzhen (CN); Yungjui Lee, Shenzhen (CN)

(73) Assignee: SHENZHEN CHINA STAR OPTOELECTRONICS TECHNOLOGY CO., LTD., Shenzhen, Guangdong (CN)

(21) Appl. No.: 14/423,125

(22) PCT Filed: Feb. 8, 2015
(86) PCT No.: PCT/CN2015/072465

§ 371 Date: Feb. 21, 2015

(30) Foreign Application Priority Data
Dec. 23, 2014 (CN) 201410812020.9

(51) Int. Cl. G02F 1/1335; G02F 1/017

(52) U.S. Cl. CPC G02F 1/133617; G02F 1/133516; G02F 1/017; G02F 1/133528; G02F 1/133514; G02F 2001/01791; G02F 2001/133614

(57) ABSTRACT

The present invention provides a manufacture method of a quantum-dot color filter, comprising: step 1, employing Bewendi method to compose quantum-dots (100) having a core shell structure, and obtaining quantum-dots having various grain sizes, comprising red quantum-dots (200) and green quantum-dots (300) by changing composition condition in the manufacture process; step 2, respectively processing surfaces of the red quantum-dots and the green quantum-dots with function of dispersant for stable dispersion to obtain stabilized red quantum-dots (200) and green quantum-dots (300); step 3, respectively dispersing and dissolving the stabilized red quantum-dots and green quantum-dots with resin, monomer, photoinitiator and additive agent in a solvent to form photosensitive dispersion containing red and green quantum-dots; step 4, employing the photosensitive dispersion containing red and green quantum-dots to form a pixel pattern.

### FIELD OF THE INVENTION

The present invention relates to a display technology field, and more particularly to a manufacture method of a quantum-dot color filter and a liquid crystal display device.

### BACKGROUND OF THE INVENTION

The color of the present LCD (Liquid Crystal Display) relies on the CF (color filter) to realize. The CF layer is formed by color light block materials with a series of photolithography processes. The common CF light block material is formed by dissolving and dispersing resin (polymer), monomer, photoinitiator and pigment in the solvent.

The pigment is the substance that makes the CF to realize colors. When the light emitted by the back light module passes through the RGB CF layer, only the light corresponding to the R, G, B wave bands can pass through, and the light of other wave bands is absorbed by the pigment. Therefore, the light generates RGB colors after passing through the CF layer. The present common RGB pigments are R254, R177, G58 and B166. On one hand, the transmission peaks of these organic pigments are wider and the color densities are restricted, which makes the liquid crystal display hard to realize border color gamut; on the other hand, most of the light passing through the CF layer is absorbed (the loss rate is about 66%), and only small proportional light can pass through. Therefore, the light efficiency is extremely low (generally the entire light efficiency is lower than 5%). The QDs (Quantum-Dots) are some extremely small semiconductor nano crystals, which comprise zincum, cadmium, selenium and sulphur atoms. The grain diameters of the crystals are less than 10 nm. Different from the pigment, the quantum-dots emit light as being excited by electricity or light. The wavelength of the emitting light is extremely narrow and the color is pure. The color of the emitting light is decided by the composition material, the diameter and the shape of the quantum-dots. The size is smaller, the light will be more like blue, and the size is larger, the light will be more like red. With the precise control, the colorful R, G, B light can be emitted. Therefore, the brightness of the display screen and the vividness of the images can be tremendously promoted and save energy if the quantum-dots are applied in the color block material.

The present quantum-dot color filters are all located inside the cell. The principles of generating colors by the quantum-dots and the commonly used pigment in the color filter are different. The quantum-dots are excited by light and the energy band structure of the quantum-dot changes to emit light having a specific wavelength. The back light of the liquid crystal display generates a linearly polarized light of specific direction after passing through the polarizer. The polarization state of the polarized light of specific direction will be changed (the directions of depolarization and polarization are changed) after the linearly polarized light excites the quantum-dots. Therefore, the light path and the brightness become uncontrollable.

### SUMMARY OF THE INVENTION

An objective of the present invention is to provide a manufacture method of a quantum-dot color filter, and the process of the manufacture method is simple and easy to realize.

Another objective of the present invention is to provide a liquid crystal display device, which the quantum-dot color filter is located outside the upper, lower polarizers to prevent that the light efficiency descends due to the change to the polarization state made by the quantum-dots. Accordingly, the liquid crystal display device possesses border color gamut and higher brightness, and saves energy.

For realizing the aforesaid objectives, the present invention provides a manufacture method of a quantum-dot color filter, comprising steps of:

step 1, employing Bewendi method to compose quantum-dots having a core shell structure, and obtaining quantum-dots having various grain sizes, comprising red quantum-dots and green quantum-dots by changing composition condition in the manufacture process, and the grain sizes of the red quantum-dots are 5-7 nm, the grain sizes of the green quantum-dots are 3-5 nm;

step 2, respectively processing surfaces of the red quantum-dots and the green quantum-dots with function of dispersant for stable dispersion to obtain stabilized red quantum-dots and green quantum-dots;

step 3, respectively dispersing and dissolving the stabilized red quantum-dots and green quantum-dots with resin, monomer, photoinitiator and additive agent in a solvent to form photosensitive dispersion containing red and green quantum-dots;

step 4, employing the photosensitive dispersion containing red and green quantum-dots to form a pixel pattern.

In the step 1, a range of grain sizes of the quantum-dots is 3-8 nm, the grain sizes of the red quantum-dots are 5-7 nm, and the grain sizes of the green quantum-dots are 3-5 nm.

The manufacture process of quantum-dots in the step 1 comprises:

step 11, manufacturing CdS cores of the quantum-dots;

step 12, manufacturing ZnS shells covering the exterior of the CdS cores.

In the step 3 and the total weight of the photosensitive dispersion is as the base in the photosensitive dispersion containing red quantum-dots, a content of the stabilized red quantum-dots is 5-20 wt %, and a content of the resin is 2-15 wt %, and a content of the monomer is 3-10 wt %, and a content of the photoinitiator is 0.1-0.6 wt %, and a content of the additive agent is 0.1-2 wt %, and a content of the solvent is 70-90 wt %;

the total weight of the photosensitive dispersion is as the base in the photosensitive dispersion containing green quantum-dots, a content of the stabilized red quantum-dots is 5-20 wt %, and a content of the resin is 2-15 wt %, and a content of the monomer is 3-10 wt %, and a content of the photoinitiator is 0.1-0.6 wt %, and a content of the additive agent is 0.1-2 wt %, and a content of the solvent is 70-90 wt %.

The dispersant in the step 2 is a micromoleculer coupling agent or an amphiphilic macromolecular coupling agent.

In the step 3, the resin is polyacrylate polymer, and the monomer is polyhydroxy acrylics monomer, and the solvent is solvent of one or more kinds of propylene glycol monomethyl ether propionates; the photoinitiator is acetophenone group, biimidazole, benzoin group or benzophenone; the additive agent is at least one of leveling agent, defoamer and heat stabilizer.

The pixel pattern is formed in the step 4 by spray coating or patterning.

The present invention further provides a liquid crystal display device, comprising a liquid crystal panel and a back light module located under the liquid crystal panel, and the liquid crystal panel comprises a first substrate and a second substrate, which are oppositely located, a liquid crystal layer located between the first substrate and the second substrate, an upper polarizer, located at one side of the first substrate away from the liquid crystal layer, a lower polarizer, located at one side of the second substrate away from the liquid crystal layer and a quantum-dot color filter located between the back light module and the lower polarizer.

The back light module is a blue-fluorescence light source, and a red quantum-dot pixel pattern and a green quantum-dot pixel pattern are formed at one side of the quantum-dot color filter close to the lower polarizer.

The present invention further provides a manufacture method of a quantum-dot color filter, comprising steps of:

step 1, employing Bewendi method to compose quantum-dots having a core shell structure, and obtaining quantum-dots having various grain sizes, comprising red quantum-dots and green quantum-dots by changing composition condition in the manufacture process;

step 2, respectively processing surfaces of the red quantum-dots and the green quantum-dots with function of dispersant for stable dispersion to obtain stabilized red quantum-dots and green quantum-dots;

step 3, respectively dispersing and dissolving the stabilized red quantum-dots and green quantum-dots with resin, monomer, photoinitiator and additive agent in a solvent to form photosensitive dispersion containing red and green quantum-dots;

step 4, employing the photosensitive dispersion containing red and green quantum-dots to form a pixel pattern;

wherein in the step 1, a range of grain sizes of the quantum-dots is 3-8 nm, the grain sizes of the red quantum-dots are 5-7 nm, the grain sizes of the green quantum-dots are 3-5 nm;

wherein the manufacture process of quantum-dots in the step 1 comprises:

step 11, manufacturing CdS cores of the quantum-dots;

step 12, manufacturing ZnS shells covering the exterior of the CdS cores;

wherein in the step 3 and the total weight of the photosensitive dispersion is as the base in the photosensitive dispersion containing red quantum-dots, a content of the stabilized red quantum-dots is 5-20 wt %, and a content of the resin is 2-15 wt %, and a content of the monomer is 3-10 wt %, and a content of the photoinitiator is 0.1-0.6 wt %, and a content of the additive agent is 0.1-2 wt %, and a content of the solvent is 70-90 wt %;

the total weight of the photosensitive dispersion is as the base in the photosensitive dispersion containing green quantum-dots, a content of the stabilized red quantum-dots is 5-20 wt %, and a content of the resin is 2-15 wt %, and a content of the monomer is 3-10 wt %, and a content of the photoinitiator is 0.1-0.6 wt %, and a content of the additive agent is 0.1-2 wt %, and a content of the solvent is 70-90 wt %.

The benefits of the present invention are that the manufacture method of the quantum-dot color filter provided by the present invention is simple and easy to realize. One blue quantum-dot pixel pattern process can be eliminated in comparison with the present common RGB process. The liquid crystal display device of the present invention utilizes the back light module generating blue-fluorescence as the light source. One blue quantum-dot pixel pattern process can be eliminated in comparison with the present common RGB process, and the quantum-dot color filter is located outside the polarizer to prevent that the light efficiency descends due to the change to the polarization state made by the quantum-dots. Accordingly, the liquid crystal display device possesses border color gamut and higher brightness, and saves energy.

### BRIEF DESCRIPTION OF THE DRAWINGS

The technical solution and the beneficial effects of the present invention are best understood from the following detailed description with reference to the accompanying figures and embodiments.

In drawings,

FIG. 1 is a flowchart of a manufacture method of a quantum-dot color filter according to the present invention;

FIG. 2 is a diagram showing steps 1-2 of the manufacture method of the quantum-dot color filter according to the present invention;

FIG. 3 is a structural diagram of a liquid crystal display device according to the present invention.

### DETAILED DESCRIPTION OF PREFERRED EMBODIMENTS

For better explaining the technical solution and the effect of the present invention, the present invention will be further described in detail with the accompanying drawings and the specific embodiments.

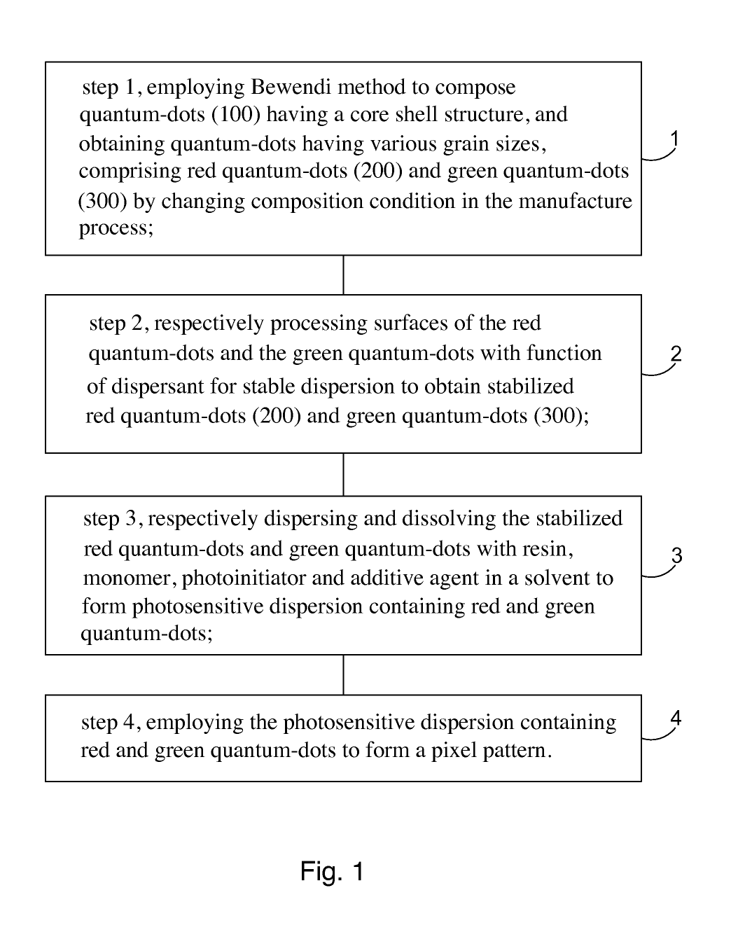

Please refer to FIG. 1. The present invention provides manufacture method of a quantum-dot color filter, comprising:

step 1, employing Bewendi method to compose quantum-dots 100 having a core shell structure, and obtaining quantum-dots having various grain sizes, comprising red quantum-dots 200 and green quantum-dots 300 by changing composition condition in the manufacture process.

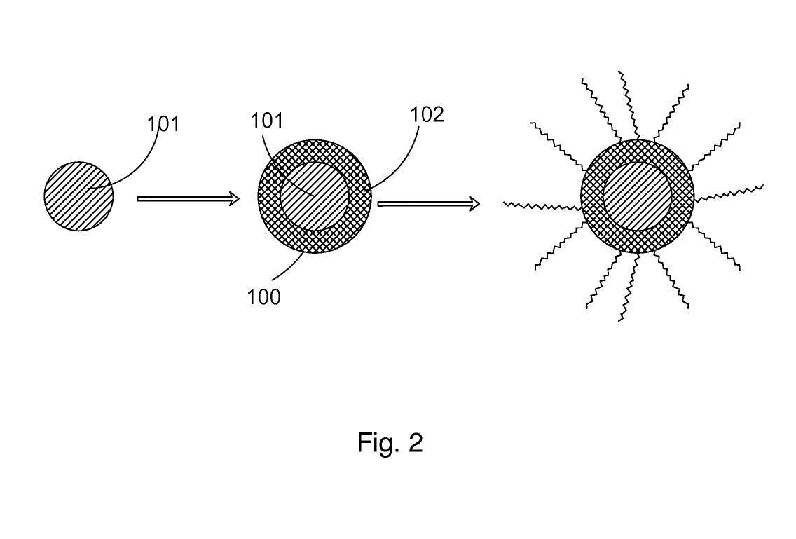

Specifically, please refer to FIG. 2, the manufacture process of quantum-dots 100 in the step 1 comprises:

step 11, manufacturing CdS cores 101 of the quantum-dots 100.

step 12, manufacturing ZnS shells 102 covering the exterior of the CdS cores 101.

The grain sizes of the CdS cores 101 are 2-5 nm, and a range of grain sizes of the quantum-dots 100 is 3-8 nm; the grain sizes of the red quantum-dots 200 are 5-7 nm, the grain sizes of the green quantum-dots 300 are 3-5 nm.

Specifically, the blue light has higher energy which can excite the red quantum-dots (quantum-dots emitting red light) and the green quantum-dots (quantum-dots emitting green light) to respectively generate red, green light. Therefore, the back light module generating blue-fluorescence can be used as the light source. The blue light is provided by the back light module. Accordingly, the quantum-dot color filter can manufacture only the red quantum-dot pixel pattern and the green quantum-dot pixel pattern. One blue quantum-dot pixel pattern process can be eliminated in comparison with the present common RGB process.

step 2, respectively processing surfaces of the red quantum-dots and the green quantum-dots with function of dispersant for stable dispersion to obtain stabilized red quantum-dots 200 and green quantum-dots 300.

The dispersant in the step 2 is a micromoleculer coupling agent or an amphiphilic macromolecular coupling agent.

step 3, respectively dispersing and dissolving the stabilized red quantum-dots and green quantum-dots with resin, monomer, photoinitiator and additive agent in a solvent to form photosensitive dispersion containing red and green quantum-dots.

Specifically, the photoinitiator is acetophenone group, biimidazole, benzoin (styrax) group or benzophenone;

the acetophenone group is a,a-Diethoxyacetophenone, 2-Hydroxy-2-methylpropiophenone (HMPP) or 2-methyl-2-morpholino-1-(4-methyl-phenylthio) propane-1-ketone, etc;

the benzoin (styrax) group is benzyl, 2-Phenylacetophenone alcohol or benzoin Ether, etc.

The additive agent is at least one of leveling agent, defoamer and heat stabilizer.

The total weight of the photosensitive dispersion is as the base in the photosensitive dispersion containing red quantum-dots, a content of the stabilized red quantum-dots is 5-20 wt %, and a content of the resin is 2-15 wt %, and a content of the monomer is 3-10 wt %, and a content of the photoinitiator is 0.1-0.6 wt %, and a content of the additive agent is 0.1-2 wt %, and a content of the solvent is 70-90 wt %.

The total weight of the photosensitive dispersion is as the base in the photosensitive dispersion containing green quantum-dots, a content of the stabilized red quantum-dots is 5-20 wt %, and a content of the resin is 2-15 wt %, and a content of the monomer is 3-10 wt %, and a content of the photoinitiator is 0.1-0.6 wt %, and a content of the additive agent is 0.1-2 wt %, and a content of the solvent is 70-90 wt %.

In the step 3, the resin is polyacrylate polymer, and the monomer is polyhydroxy acrylics monomer, and the solvent is solvent of one or more kinds of propylene glycol monomethyl ether propionates.

step 4, employing the photosensitive dispersion containing red and green quantum-dots to form a pixel pattern.

The pixel pattern is formed in the step 4 by spray coating or patterning. Specifically, the patterning can comprise processes of coating, exposure, development, et cetera.

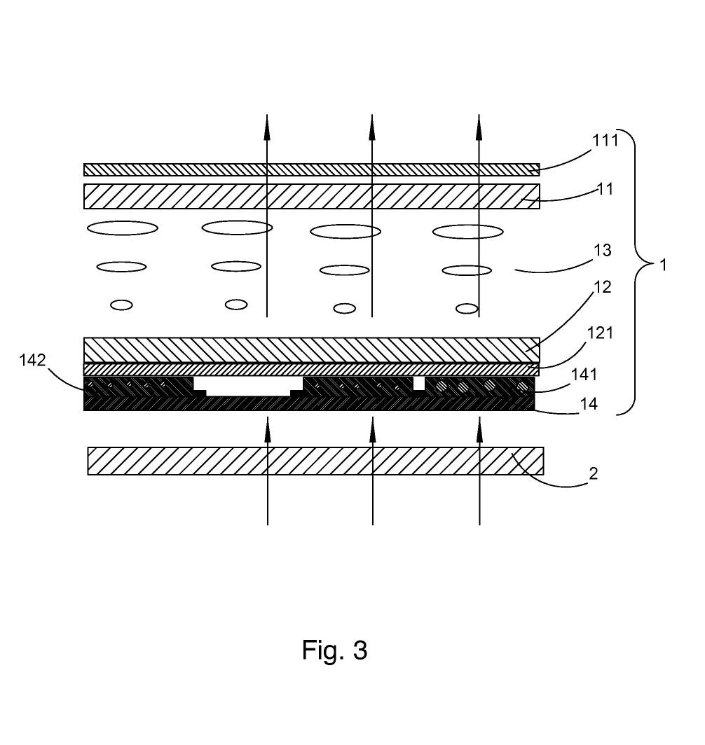

Please refer to FIG. 3. The present invention further provides a liquid crystal display device, comprising a liquid crystal panel 1 and a back light module 2 located under the liquid crystal panel 1, and the liquid crystal panel comprises a first substrate 11 and a second substrate 12, which are oppositely located, a liquid crystal layer 13 located between the first substrate 11 and the second substrate 12, an upper polarizer 111, located at one side of the first substrate 11 away from the liquid crystal layer 13, a lower polarizer 121, located at one side of the second substrate 12 away from the liquid crystal layer 13 and a quantum-dot color filter 14 located between the back light module 2 and the lower polarizer 121.

Because the light emitted by the quantum-dots possesses properties of narrow wavelength (small half peak), bright color (high color density), the color filter containing quantum-dots can make the liquid crystal display device have border color gamut. Meanwhile, because the light efficiency of the quantum-dots is high (the light efficiency of the quantum-dots can reach up over 88%), the brightness of the liquid crystal display device can be better and save energy. Moreover, in the structure, the quantum-dot color filter is designed outside the upper, lower polarizer to prevent that the light efficiency descends due to the change to the polarization state made by the quantum-dots. In the preferred embodiment, the quantum-dot color filter is located between the back light module and the lower polarizer.

The back light module 2 is a blue-fluorescence light source, and a red quantum-dot pixel pattern 141 and a green quantum-dot pixel pattern 142 is formed at one side of the quantum-dot color filter 14 close to the lower polarizer 121. The blue light has higher energy which can excite the red quantum-dots (quantum-dots emitting red light) and the green quantum-dots (quantum-dots emitting green light) to respectively generate red, green light. Therefore, the back light module generating blue-fluorescence can be used as the light source. The blue light is provided by the back light module. Accordingly, the quantum-dot color filter can manufacture only the red quantum-dot pixel pattern and the green quantum-dot pixel pattern. One blue quantum-dot pixel pattern process can be eliminated in comparison with the present common RGB process.

In conclusion, the manufacture method of the quantum-dot color filter provided by the present invention is simple and easy to realize. One blue quantum-dot pixel pattern process can be eliminated in comparison with the present common RGB process. The liquid crystal display device of the present invention utilizes the back light module generating blue-fluorescence as the light source. One blue quantum-dot pixel pattern process can be eliminated in comparison with the present common RGB process, and the quantum-dot color filter is located outside the polarizer to prevent that the light efficiency descends due to the change to the polarization state made by the quantum-dots. Accordingly, the liquid crystal display device possesses border color gamut and higher brightness, and saves energy.

Above are only specific embodiments of the present invention, the scope of the present invention is not limited to this, and to any persons who are skilled in the art, change or replacement which is easily derived should be covered by the protected scope of the invention. Thus, the protected scope of the invention should go by the subject claims.

What is claimed is:

1. A manufacture method of a quantum-dot color filter, comprising steps of:
step 1, employing Bewendi method to compose quantum-dots having a core shell structure, and obtaining quantum-dots having various grain sizes, comprising red quantum-dots and green quantum-dots by changing composition condition in the manufacture process;
step 2, respectively processing surfaces of the red quantum-dots and the green quantum-dots with function of dispersant for stable dispersion to obtain stabilized red quantum-dots and green quantum-dots;
step 3, respectively dispersing and dissolving the stabilized red quantum-dots and green quantum-dots with resin, monomer, photoinitiator and additive agent in a solvent to form photosensitive dispersion containing red and green quantum-dots;
step 4, employing the photosensitive dispersion containing red and green quantum-dots to form a pixel pattern.

2. The manufacture method of the quantum-dot color filter according to claim 1, wherein in the step 1, a range of grain sizes of the quantum-dots is 3-8 nm, the grain sizes of the red quantum-dots are 5-7 nm, the grain sizes of the green quantum-dots are 3-5 nm.

3. The manufacture method of the quantum-dot color filter according to claim 1, wherein the manufacture process of quantum-dots in the step 1 comprises:
step 11, manufacturing CdS cores of the quantum-dots;
step 12, manufacturing ZnS shells covering the exterior of the CdS cores.

4. The manufacture method of the quantum-dot color filter according to claim 1, wherein in the step 3 and the total weight of the photosensitive dispersion is as the base in the photosensitive dispersion containing red quantum-dots, a content of the stabilized red quantum-dots is 5-20 wt %, and a content of the resin is 2-15 wt %, and a content of the monomer is 3-10 wt %, and a content of the photoinitiator is 0.1-0.6 wt %, and a content of the additive agent is 0.1-2 wt %, and a content of the solvent is 70-90 wt %;
the total weight of the photosensitive dispersion is as the base in the photosensitive dispersion containing green quantum-dots, a content of the stabilized red quantum-dots is 5-20 wt %, and a content of the resin is 2-15 wt %, and a content of the monomer is 3-10 wt %, and a content of the photoinitiator is 0.1-0.6 wt %, and a content of the additive agent is 0.1-2 wt %, and a content of the solvent is 70-90 wt %.

5. The manufacture method of the quantum-dot color filter according to claim 1, wherein the dispersant in the step 2 is a micromoleculer coupling agent or an amphiphilic macromolecular coupling agent.

6. The manufacture method of the quantum-dot color filter according to claim 1, wherein in the step 3, the resin is polyacrylate polymer, and the monomer is polyhydroxy acrylics monomer, and the solvent is solvent of one or more kinds of propylene glycol monomethyl ether propionates; the photoinitiator is acetophenone group, biimidazole, benzoin group or benzophenone; the additive agent is at least one of leveling agent, defoamer and heat stabilizer.

7. The manufacture method of a quantum-dot color filter according to claim 1, wherein the pixel pattern is formed in the step 4 by spray coating or patterning.

8. A liquid crystal display device, comprising a liquid crystal panel and a back light module located under the liquid crystal panel, and the liquid crystal panel comprises a first substrate and a second substrate, which are oppositely located, a liquid crystal layer located between the first substrate and the second substrate, an upper polarizer, located at one side of the first substrate away from the liquid crystal layer, a lower polarizer, located at one side of the second substrate away from the liquid crystal layer and a quantum-dot color filter located between the back light module and the lower polarizer.

9. The liquid crystal display device according to claim 8, wherein the back light module is a blue-fluorescence light source, and a red quantum-dot pixel pattern and a green quantum-dot pixel pattern are formed at one side of the quantum-dot color filter close to the lower polarizer.

10. A manufacture method of a quantum-dot color filter, comprising steps of:
step 1, employing Bewendi method to compose quantum-dots having a core shell structure, and obtaining quantum-dots having various grain sizes, comprising red quantum-dots and green quantum-dots by changing composition condition in the manufacture process;
step 2, respectively processing surfaces of the red quantum-dots and the green quantum-dots with function of dispersant for stable dispersion to obtain stabilized red quantum-dots and green quantum-dots;
step 3, respectively dispersing and dissolving the stabilized red quantum-dots and green quantum-dots with resin, monomer, photoinitiator and additive agent in a solvent to form photosensitive dispersion containing red and green quantum-dots;
step 4, employing the photosensitive dispersion containing red and green quantum-dots to form a pixel pattern;
wherein in the step 1, a range of grain sizes of the quantum-dots is 3-8 nm, the grain sizes of the red quantum-dots are 5-7 nm, the grain sizes of the green quantum-dots are 3-5 nm;
wherein the manufacture process of quantum-dots in the step 1 comprises:
step 11, manufacturing CdS cores of the quantum-dots;
step 12, manufacturing ZnS shells covering the exterior of the CdS cores;
wherein in the step 3 and the total weight of the photosensitive dispersion is as the base in the photosensitive dispersion containing red quantum-dots, a content of the stabilized red quantum-dots is 5-20 wt %, and a content of the resin is 2-15 wt %, and a content of the monomer is 3-10 wt %, and a content of the photoinitiator is 0.1-0.6 wt %, and a content of the additive agent is 0.1-2 wt %, and a content of the solvent is 70-90 wt %;
the total weight of the photosensitive dispersion is as the base in the photosensitive dispersion containing green quantum-dots, a content of the stabilized red quantum-dots is 5-20 wt %, and a content of the resin is 2-15 wt %, and a content of the monomer is 3-10 wt %, and a content of the photoinitiator is 0.1-0.6 wt %, and a content of the additive agent is 0.1-2 wt %, and a content of the solvent is 70-90 wt %.

11. The manufacture method of the quantum-dot color filter according to claim 10, wherein the dispersant in the step 2 is a micromoleculer coupling agent or an amphiphilic macromolecular coupling agent.

12. The manufacture method of the quantum-dot color filter according to claim 10, wherein in the step 3, the resin is polyacrylate polymer, and the monomer is polyhydroxy acrylics monomer, and the solvent is solvent of one or more kinds of propylene glycol monomethyl ether propionates; the photoinitiator is acetophenone group, biimidazole, benzoin group or benzophenone; the additive agent is at least one of leveling agent, defoamer and heat stabilizer.

13. The manufacture method of a quantum-dot color filter according to claim 10, wherein the pixel pattern is formed in the step 4 by spray coating or patterning.
